(19) United States
(12) Patent Application Publication
(10) Pub. No.: US 2007/0274002 A1
(43) Pub. Date: Nov. 29, 2007

(54) Spindle motor

(75) Inventors: Pyo Kim, Gyunggi-do (KR); Nam Seok Kim, Gyunggi-do (KR); Sang Kyu Lee, Gyunggi-do (KR); Viatcheslav Smirnov, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/802,749

(22) Filed: May 24, 2007

(30) Foreign Application Priority Data
May 25, 2006 (KR) 10-2006-0047131

(51) Int. Cl. G11B 17/02

(52) U.S. Cl. 360/99.08

(57) ABSTRACT

The present invention provides a spindle motor. The spindle motor 100 includes a rotor casing 142 for rotating a recording medium, a rotary shaft 141 securely mounted to the rotor casing 142, a bearing 115 for rotatably supporting the rotary shaft 141, a bearing holder 113 for securely supporting the bearing, with a locking part 114 protruding around the upper end of the outer circumferential surface of the bearing holder 113, and a hooking part 150 provided in the rotor casing 142 to engage with the locking part 114 of the bearing holder 113, thus preventing the rotor casing 142 from being removed from the bearing holder 113. The hooking part 150 has a hook part 153 having a hook-shaped section. The hook part 153 has an angle of inclination of 10° relative to a horizontal surface.

### CROSS REFERENCE TO RELATED APPLICATION

This application claims the benefit of Korean Patent Application No. 10-2006-0047131, filed on May 25, 2006, entitled Spindle Motor, which is hereby incorporated by reference in its entirety into this application.

### BACKGROUND OF THE INVENTION

1. Field of the Invention

The present invention relates, in general, to spindle motors and, more particularly, to a spindle motor, in which a rotary shaft has a reduced length while securing the maximum contact surface between the rotary shaft and a bearing, thus realizing compactness of spindle motors.

2. Description of the Related Art

A conventional spindle motor is configured such that the rotary shaft is supported by an oil film, which is formed from lubrication oil at a location between the bearing and the shaft. Thus, the spindle motor can maintain high precision rotating performance, and thus the spindle motor has been preferably used as a motor for drive devices for rotating recording media, requiring high speed rotation, such as hard disk drives (HDD) or optical disc drives (ODD).

In the drive devices for rotating recording media at high speeds, one of the most important goals is to rotate a disc at a high speed without vibrating the disc. To rotate a disc at a high speed without vibrating the disc, the spindle motor must have high durability and must maintain stable balance on a turntable on which a disc is seated and is rotated at the high speed. An example of conventional spindle motors is schematically illustrated in FIG. 5.

As shown in FIG. 5, the conventional spindle motor 200 comprises a support part 210 and a rotary part 240, which is rotatably supported by the support part 210.

The support part 210 comprises a frame 211, a bearing holder 213, a bearing 215, an armature 216, a thrust washer 219 and a thrust washer cover 221.

The frame 211 firmly supports all elements of the support part 210, and is securely installed in a drive device, such as a hard disc drive (HDD), in which the spindle motor 200 is used.

The bearing holder 213 stably supports the bearing 215 therein, and has a hollow cylindrical structure, and is securely mounted at an end thereof to the frame 211 through caulking.

The bearing 215, which rotatably supports a rotary shaft 241, is made of an appropriate material, such as metal, and is formed into a cylindrical shape. The bearing 215 is installed in the motor 200 such that the central axis of the bearing 215 corresponds to the central axis of the rotary shaft 241. Further, a predetermined lubricant is contained in a gap between the bearing 215 and the rotary shaft 241, thus allowing the rotary shaft 241 to be more smoothly rotated while reducing friction between the bearing 215 and the shaft 241.

The armature 216 induces an electromagnetic field when it is activated by electricity, which is applied thereto from an external electric power source. The armature 216 comprises a core 217 and a coil 218, which is wound around the core 217.

The core 217 is made of a predetermined metal material and is securely fitted over the outer circumferential surface of the bearing holder 213.

When the coil 218 of the armature 216 is activated by electricity, which is applied thereto from the external electric power source, an electromagnetic field is induced between the coil 218 and the magnet 243 of a rotor casing 242, thus rotating the rotor casing 242.

The thrust washer 219, which supports the rotary shaft 241, is securely installed in the bearing holder 213 by the thrust washer cover 221 such that the washer 219 is in contact with the lower end of the rotary shaft 241. In the above state, the washer cover 221 is fixed in the bearing holder 213 through fitting.

The rotary part 240 comprises the rotary shaft 241, the rotor casing 242 and a stopper 251.

The rotary shaft 241 rotatably supports the rotary part 240 relative to the support part 210, and is rotatably inserted into the bearing 215 such that the central axis thereof coincides with the central axis of the bearing 215.

Further, the lower end of the rotary shaft 241 is supported by the thrust washer 219 and the outer circumferential surface of the shaft 241 is rotatably supported by the bearing 215 while the shaft 241 is not in contact with the bearing 215.

The rotor casing 242 functions to seat a recording medium (not shown) thereon and rotate it. The rotor casing 242 is securely mounted to the rotary shaft 241 and is provided at the center thereof with a damper (not shown) for clamping a disc on the rotor casing 242.

Further, the magnet 243 is securely mounted on the inner circumferential surface of a skirt of the rotor casing 242 such that the magnet 243 faces the armature 216, thus inducing an electromagnetic field between the magnet 243 and the armature 216 and generating a rotating force for rotating the rotor casing 242. In other words, when electric current is applied to the coil 218, rotating force is electromagnetically induced between the coil 218 and the magnet 243, so that the rotary part 240 can be rotated relative to the stationary support part 210.

Further, a rubber turntable 244, having an annular shape, is securely mounted to the edge of the upper surface of the rotor casing 242, so that a disc (not shown) can be stably seated on the rotor casing 242 without slipping over the casing 242.

The stopper 251 functions to prevent the rotary part 240 from being removed from the support part 210. The stopper 251 has a thin annular shape and is installed in an annular groove 245, which is formed around the lower end of the rotary shaft 241, through fitting. When the spindle motor 200 is rotated at a high speed, a lift force acts both on the rotor casing 242 and on the rotary shaft 241, so that both the rotor casing 242 and the rotary shaft 241 are biased upwards by the lift force. In the above state, the stopper 251 prevents the rotary shaft 241 from being removed from the bearing 215 by the lift force.

However, in the spindle motor 200 having the above-mentioned construction, because the annular groove 245 for holding the stopper 251 is formed around the rotary shaft 241, the length of the rotary shaft 241 is undesirably increased by the height H of the annular groove 245.

Further, due to both the thickness of the stopper 251 and the area occupied by the annular groove 241, the effective contact surface between the rotary shaft 241 and the bearing 215 is reduced, so that the spindle motor 200 cannot realize stable driving performance.

### SUMMARY OF THE INVENTION

Accordingly, the present invention has been made in an effort to provide a spindle motor having the advantage of reducing the length of the rotary shaft by providing a hooking part on the rotor casing to prevent the rotary part from being removed from the bearing.

Further, the present invention has been made in an effort to provide a spindle motor having the advantage of reducing the length of the rotary shaft without reducing the effective contact surface between the rotary shaft and the bearing, thus realizing the stable driving performance of the spindle motor.

In one aspect of the present invention, there is provided a spindle motor comprising: a rotary part for rotating a recording medium; a support part for rotatably supporting the rotary part; and a hooking part provided in the rotary part such that the hooking part engages with at least part of the support part, thus preventing the rotary part from being removed from the support part.

In the spindle motor, the hooking part may be detachably inserted into the rotary part.

In an embodiment of the present invention, there is provided a spindle motor comprising: a rotor casing for rotating a recording medium; a rotary shaft securely mounted to the rotor casing; a bearing for rotatably supporting the rotary shaft; a bearing holder for securely supporting the bearing, with a locking part protruding around the upper end of the outer circumferential surface of the bearing holder; and a hooking part provided in the rotor casing to engage with the locking part of the bearing holder, thus preventing the rotor casing from being removed from the bearing holder.

In the spindle motor, the hooking part may comprise a hook part having a hook-shaped section.

Further, the hook part may have an angle of inclination of 10° relative to a horizontal surface.

In an embodiment, the hooking part is produced through plastic injection molding and is detachably inserted into the rotor casing.

Further, the hooking part may prevent the leakage of lubricant from between the bearing and the rotary shaft.

The spindle motor according to the embodiment may further comprise an armature, which is provided on the outer circumferential surface of the bearing holder and is activated by electricity applied thereto from an electric power source, so that rotating force is electromagnetically generated between the armature and a first magnet of the rotor casing, thereby rotating the rotor casing.

The rotor casing may further comprise a second magnet, which is provided on the rotor casing such that the second magnet is in close contact with the outer circumferential surface of the hooking part, thus generating an attraction force between the second magnet and the armature.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a sectional view schematically illustrating a spindle motor according to a first embodiment of the present invention;

FIG. 2 is a perspective view schematically illustrating a hooking part of FIG. 1;

FIG. 3 is a sectional view schematically illustrating the hooking part and a locking part of FIG. 1;

FIG. 4 is a sectional view illustrating a rotor casing according to a second embodiment of the present invention; and

FIG. 5 is a sectional view schematically illustrating a conventional spindle motor.

### DETAILED DESCRIPTION OF THE INVENTION

Reference will now be made in greater detail to spindle motors according to preferred embodiments of the invention, examples of which are illustrated in the accompanying drawings. Wherever possible, the same reference numerals will be used throughout the drawings and the description to refer to the same or like parts.

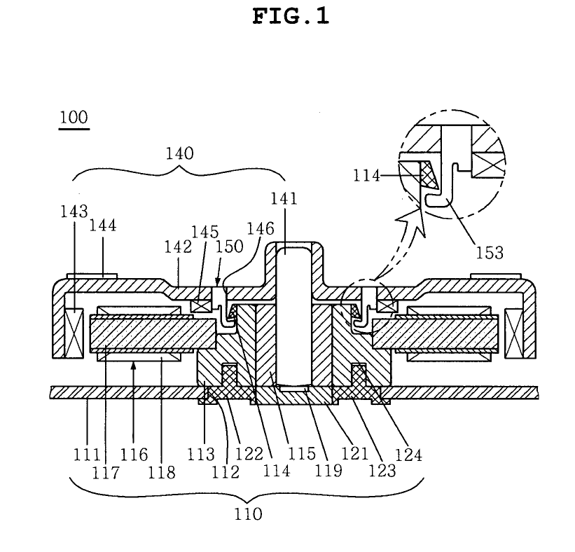

As shown in FIG. 1, the spindle motor 100 according to a preferred embodiment of the present invention comprises a support part 110 and a rotary part 140, which is rotatably supported by the support part 110.

The support part 110 comprises a frame 111, a bearing holder 113, a bearing 115, an armature 116, a thrust washer 119 and a bearing holder support 122.

The frame 111 firmly supports all the elements of the support part 110 and is securely installed in a drive device, such as a hard disc drive (HDD), in which the spindle motor 100 is used. Further, the frame 111 is made of a nonmagnetic material, such as an aluminum alloy, with an opening 112 formed through the center of the frame 111.

The bearing holder 113 stably supports the bearing 115 therein, has a hollow cylindrical structure, and is securely mounted at an end thereof to the frame 111.

Further, a locking part 114 is formed around the upper end of the outer circumferential surface of the bearing holder 113. The locking part 114 of the bearing holder 113 is locked to the hooking part 150 of a rotor casing 142, thus preventing the rotary part 140 from being removed from the support part 110.

In the embodiment of the present invention, the locking part 114 is integrally formed with the bearing holder 113 using the same material as that of the bearing holder 113. However, it should be understood that the locking part 114 may be formed separately from the bearing holder 113 and may be securely mounted to the bearing holder 113.

Further, in the embodiment, the bearing holder 113 is made of aluminum or an aluminum alloy, which is lighter than the material of the bearing holder of the conventional spindle motor, thus satisfying the recent trend toward lightness of the spindle motor 100.

The bearing 115, which rotatably supports a rotary shaft 141, is made of an appropriate material, such as metal, and formed into a cylindrical shape. The bearing 115 is installed in the motor 100 such that the central axis of the bearing 115 coincides with the central axis of the rotary shaft 141. Further, a predetermined lubricant is contained in the gap between the bearing 115 and the rotary shaft 141, thus allowing the rotary shaft 141 to be more smoothly rotated while reducing friction between the bearing 115 and the shaft 141.

The armature 116 induces an electromagnetic field when it is activated by electricity, which is applied thereto from an external electric power source. The armature 116 comprises a core 117 and a coil 118, which is wound around the core 117.

The core 117 is made of a magnetic material, for example, a predetermined metal material, which can produce an attraction force between it and a magnet. The core 117 is securely fitted over the outer circumferential surface of the bearing holder 113.

When the coil 118 of the armature 116 is activated by electricity, which is applied thereto from the external electric power source, an electromagnetic field is induced between the coil 118 and a first magnet 143 of the rotor casing 142, thus rotating the rotor casing 142.

The thrust washer 119, which supports the rotary shaft 141, is securely supported in the spindle motor 100 by a thrust washer cover 121 such that the washer 119 is in contact with the lower end of the rotary shaft 141. In the above state, the thrust washer cover 121 is fixed in the bearing holder support 122 through fitting.

The bearing holder support 122 is securely mounted in the opening 112 of the frame 111 by inserting an annular rim 123 of the bearing holder support 122 into an annular groove 124 of the bearing holder 113 and by caulking the outer edge of the lower end of the bearing holder support 122 to the frame 111, thus securely supporting the bearing holder 113 on the frame 111.

The rotary part 140, which rotates a recording medium (not shown), comprises the rotary shaft 141, the rotor casing 142 and the hooking part 150.

The rotary shaft 141 rotatably supports the rotary part 140 relative to the support part 110 and is rotatably inserted into the bearing 115 such that the central axis thereof coincides with the central axis of the bearing 115.

Further, the lower end of the rotary shaft 141 is supported by the thrust washer 119 and the outer circumferential surface of the shaft 141 is rotatably supported by the bearing 115 while the shaft 141 is not in contact with the bearing 115.

The rotor casing 142 functions to seat a recording medium (not shown) thereon and rotate it. The rotor casing 142 is securely mounted to the rotary shaft 141 and is provided at the center thereof with a damper (not shown) for clamping a disc on the rotor casing 142.

Further, the first magnet 143 is securely mounted on the inner circumferential surface of the skirt of the rotor casing 142 such that the first magnet 143 faces the armature 116, thus inducing an electromagnetic field between the first magnet 143 and the armature 116 and generating a rotating force for rotating the rotor casing 142. In other words, when electric current is applied to the coil 118, a rotating force is electromagnetically induced between the coil 118 and the first magnet 143, so that the rotary part 140 can be rotated relative to the stationary support part 110.

Further, a rubber turntable 144, having an annular shape, is securely mounted to the edge of the upper surface of the rotor casing 142, so that a disc (not shown) can be stably seated on the rotor casing 142 without slipping over the casing 142. A second magnet 145, which induces an attraction force between it and the metal core 117, is mounted to the lower surface of the rotor casing 142 such that the second magnet 145 is in close contact with the outer circumferential surface of the hooking part 150. The second magnet 145 prevents the rotor casing 142 from lifting up, that is, prevents play, when the rotary part 140 is rotated at a high speed.

The hooking part 150 prevents the rotary part 140 from being removed from the support part 110, and is formed as an annular structure. The hooking part 150 is securely mounted to the rotor casing 142 such that the hooking part 150 is placed adjacent to the bearing holder 113, and comprises a body part 151 and a hook part 153.

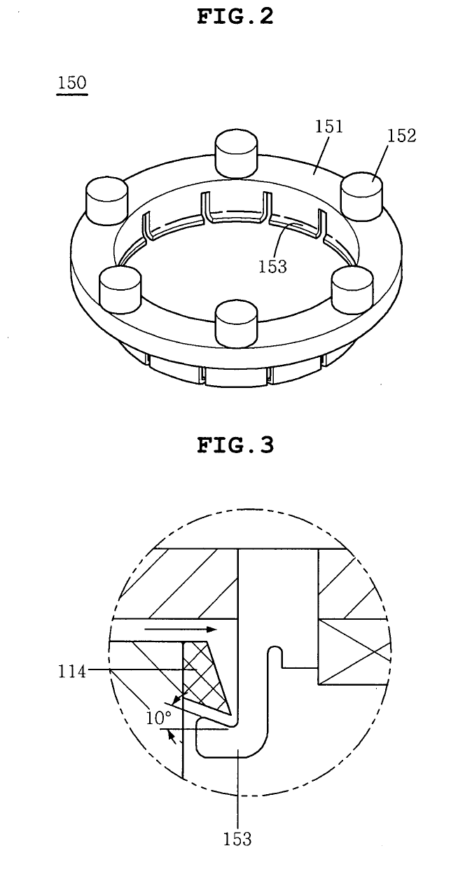

As shown in FIG. 2, the body part 151, which is assembled with the rotor casing 142, comprises a plurality of locking protrusions 152, which are locked to respective locking holes 146 of the rotor casing 142. In the embodiment, the locking protrusions 152 are fitted into the locking holes 146. However, it should be understood that the locking protrusions 152 may be fitted into and bonded to the locking holes 146 using a predetermined bonding agent.

The hook part 153 comprises a plurality of hook portions, which integrally extend from the body part 151 toward the bearing holder 113 at locations arranged along the inner circumferential surface of the body part 151 at predetermined regular intervals. The hook part 153 has an inner diameter similar to the outer diameter of the bearing holder 113.

Further, the hook part 153 is placed at a location near the bearing holder 113, so that, when the lubricant is dispersed from the gap between the rotary shaft 141 and the bearing 115 in the direction shown by the arrow of FIG. 3, during rotation of the spindle motor 100, the hook part 153 can prevent the lubricant from leaking to the outside.

Further, the lower end of the hook part 153 is bent toward the outer circumferential surface of the bearing holder 113, thus engaging with the locking part 114 of the bearing holder 113. The upper surface of the bent lower end of the hook part 153, which faces the lower surface of the locking part 114, is inclined upwards at an angle of inclination of about 10°. To correspond to the inclination angle of the hook part 153, the lower surface of the locking part 114, which faces the inclined upper surface of the bent lower end of the hook part 153, is inclined downwards at an angle of inclination of about 10°, so that, when the locking part 114 engages with the hook part 153, increased locking force is obtained.

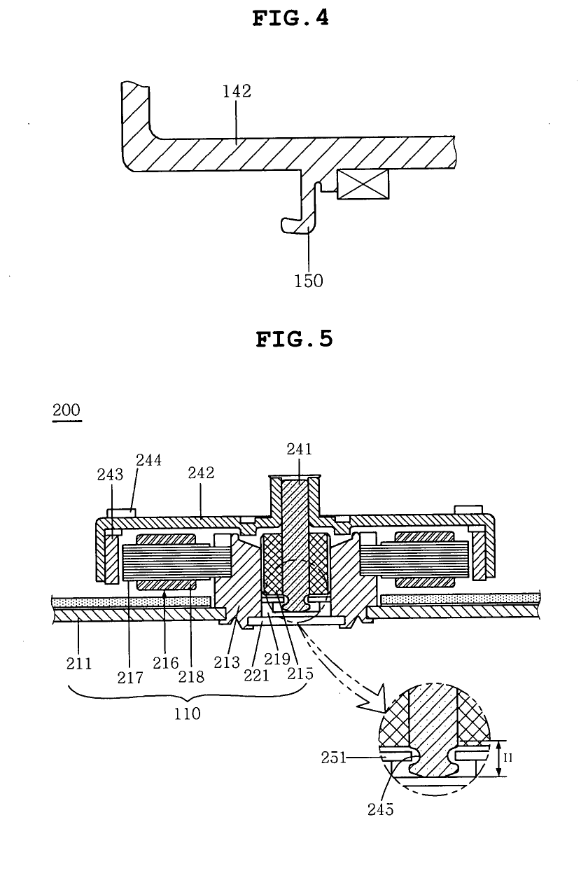

In the embodiment, the hooking part 150 is made of a plastic material having predetermined elasticity through an injection molding process and is directly inserted into the rotor casing 142. However, it should be understood that the hooking part 150 may be integrally formed with the rotor casing 142 using the same material, as shown in FIG. 4.

In the spindle motor according to the present invention, the hooking part of the rotor casing engages with the locking part of the bearing holder, thus preventing the rotor casing from being removed from the bearing holder. Therefore, the length of the rotary shaft can be reduced without reducing the effective contact surface between the rotary shaft and the bearing. Thus, a compact and thin spindle motor can be produced.

Further, the hooking part is provided at a location near the bearing holder, so that, when the spindle motor is rotated at a high speed, lubricant is prevented from leaking from the gap between the bearing and the rotary shaft to the outside of the motor.

Further, the hooking part is produced using a synthetic resin material, such as a plastic material, which is lighter than the material of the rotor casing, and is installed in the rotor casing, so that the elements of the spindle motor can be easily and simply produced and lightness of the spindle motor can be accomplished.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A spindle motor comprising:
a rotary part for rotating a recording medium;
a support part for rotatably supporting the rotary part; and
a hooking part provided in the rotary part such that the hooking part engages with at least part of the support part, thus preventing the rotary part from being removed from the support part.

2. The spindle motor according to claim 1, wherein the hooking part is detachably inserted into the rotary part.

3. A spindle motor comprising:
a rotor casing for rotating a recording medium;
a rotary shaft securely mounted to the rotor casing;
a bearing for rotatably supporting the rotary shaft;
a bearing holder for securely supporting the bearing, with a locking part protruding around an upper end of an outer circumferential surface of the bearing holder; and
a hooking part provided in the rotor casing to engage with the locking part of the bearing holder, thus preventing the rotor casing from being removed from the bearing holder.

4. The spindle motor according to claim 3, wherein the hooking part prevents a leakage of lubricant from between the bearing and the rotary shaft.

5. The spindle motor according to claim 4, further comprising:
an armature provided on the outer circumferential surface of the bearing holder and activated by electricity applied thereto from an electric power source, so that rotating force is generated between the armature and a first magnet of the rotor casing, thereby rotating the rotor casing.

6. The spindle motor according to claim 5, wherein the rotor casing further comprises a second magnet provided on the rotor casing such that the second magnet is in close contact with an outer circumferential surface of the hooking part, thus generating attraction force between the second magnet and the armature.

7. The spindle motor according to claim 3, wherein the hooking part comprises a hook part having a hook-shaped section.

8. The spindle motor according to claim 7, wherein the hooking part prevents a leakage of lubricant from between the bearing and the rotary shaft.

9. The spindle motor according to claim 8, further comprising:
an armature provided on the outer circumferential surface of the bearing holder and activated by electricity applied thereto from an electric power source, so that rotating force is generated between the armature and a first magnet of the rotor casing, thereby rotating the rotor casing.

10. The spindle motor according to claim 9, wherein the rotor casing further comprises a second magnet provided on the rotor casing such that the second magnet is in close contact with an outer circumferential surface of the hooking part, thus generating attraction force between the second magnet and the armature.

11. The spindle motor according to claim 7, wherein the hook part has an angle of inclination of 10° relative to a horizontal surface.

12. The spindle motor according to claim 11, wherein the hooking part prevents a leakage of lubricant from between the bearing and the rotary shaft.

13. The spindle motor according to claim 12, further comprising:
an armature provided on the outer circumferential surface of the bearing holder and activated by electricity applied thereto from an electric power source, so that rotating force is generated between the armature and a first magnet of the rotor casing, thereby rotating the rotor casing.

14. The spindle motor according to claim 13, wherein the rotor casing further comprises a second magnet provided on the rotor casing such that the second magnet is in close contact with an outer circumferential surface of the hooking part, thus generating attraction force between the second magnet and the armature.

15. The spindle motor according to claim 11, wherein the hooking part is produced through plastic injection molding and is detachably inserted into the rotor casing.

16. The spindle motor according to claims 15, wherein the hooking part prevents a leakage of lubricant from between the bearing and the rotary shaft.

17. The spindle motor according to claim 16, further comprising:
an armature provided on the outer circumferential surface of the bearing holder and activated by electricity applied thereto from an electric power source, so that rotating force is generated between the armature and a first magnet of the rotor casing, thereby rotating the rotor casing.

18. The spindle motor according to claim 17, wherein the rotor casing further comprises a second magnet provided on the rotor casing such that the second magnet is in close contact with an outer circumferential surface of the hooking part, thus generating attraction force between the second magnet and the armature.
